(19) United States
(12) Patent Application Publication
(10) Pub. No.: US 2019/0031380 A1
(43) Pub. Date: Jan. 31, 2019

(54) AUTOMATED CHANGING OF SUPPORTS FOR DIFFERENT SIZED CONTAINERS IN A CONTAINER FILLING SYSTEM

(71) Applicant: ExxonMobil Research and Engineering Company, Annandale, NJ (US)

(72) Inventor: Brian J. HRONCHEK, Lincoln University, PA (US)

(21) Appl. No.: 16/045,091

(22) Filed: Jul. 25, 2018

Related U.S. Application Data
(60) Provisional application No. 62/536,607, filed on Jul. 25, 2017.

(51) Int. Cl. B65B 37/08; B65B 43/60; B65B 3/06; B67C 7/00; B67C 3/24

(52) U.S. Cl. CPC B65B 37/08; B65B 43/60; B65B 57/145; B67C 7/0013; B67C 3/24; B65B 3/06

(57) ABSTRACT

A method of changing container sizes on a container filling carousel, the carousel and container supports thereon, which carousel has one or more pairs of side-by-side first and second container supports, each container support having a frame, a container support platform and at least one pair of container support arms above the container support platform. Each of said container supports is structured to accept a first small-sized container. The second container support is structured to accept a second larger-sized container, relative to said first small-sized container. The carousel includes a product filling head above each of said first and second container supports. The first container support can be radially retracted from a side of the second container support and from beneath its corresponding product filling head to allow the second container support to accommodate a larger-sized container.

### CROSS-REFERENCE TO RELATED APPLICATIONS

This application claims the benefit of U.S. Provisional Application No. 62/536,607, filed on Jul. 25, 2017, the entire contents of which are incorporated herein by reference.

### FIELD

Disclosed is a method and apparatus for easily changing the size of container supports on a container filling carousel, such as for filling of motor oil containers of differing sizes.

### BACKGROUND

Fully automatic liquid filling machines of known construction may be generally divided between two major architectural types or categories based upon their speed capabilities. Speed in this context refers to the number of containers or packages which are filled by the machine with a liquid product within a given time interval, most commonly expressed as containers per minute.

One major category of liquid filling machines are referred to as carousel fillers. These machines are characterized by their continuous motion, in which an array of filling nozzles or orifices rotate about a central spindle in a continuous circular manner. Empty containers to be filled with liquid are synchronously introduced into the machine and travel about the circumference of the structure. While each container is positioned under a circumferentially arranged filling nozzle, it is completely filled with liquid. Each container is so positioned for most of one complete revolution of the machine before it is synchronously removed from the machine. The carousel filler is the fastest known architecture in that its motion is continuous.

However, changeover of a carousel filler machine from one container size to accommodate another container size is laborious and time consuming, requiring manual removal and replacement of the supports for the different container sizes at each filling station. The considerable down-time during changeover equates to a great reduction in production time and capacity.

It would be advantageous to simplify the changeover between container size supports on a carousel liquid filling machine.

### SUMMARY

Presented herein is a container filling carousel comprising one or more pairs of side-by-side first and second container supports, each container support comprising a frame, a container support platform and at least one pair of container support arms above the container support platform and wherein each of the container supports is structured and arranged to accept a first small-sized container, a product filling head above and corresponding to each of the first and second container supports, wherein the first container support is radially retractable from a side of the second container support and from beneath its corresponding product filling head, and wherein the second container support is structured and arranged to accept a second larger-sized container, relative to the first small-sized container, on demand.

In one form, the second container support has two pair of container support arms, a first pair of container support arms being structured and arranged to accept the first small-sized container, and a second pair of container support arms being structured and arranged to accept the second larger-sized container.

In another form the first container support is retractable from the side of the second container support by pivoting on an axle in the frame of the first container support.

Conveniently, the first pair of container support arms of the second container support is retractable by rotating on an axle in the frame of the second container support to introduce the second pair of container support arms.

In another form, the frames for both the first and second container supports are connected to at least one pneumatic cylinder structured and arranged to cause movement of one or more elements of the first and second container supports.

Advantageously, the frame of the first container support is pivotally connected to a lower mounting arm, a first end of the pneumatic cylinder is connected to the frame of the first container support and a second end of the pneumatic cylinder is connected to the lower mounting arm, and the pneumatic cylinder is structured and arranged to retract the frame of the first container support radially inward of the carousel and remove the first container support from alignment with the corresponding product filling head.

In yet another form, the second container support has two pair of container support arms, a first pair of container support arms being structured and arranged to accept the first small-sized container, and the second pair of container support arms being structured and arranged to accept the second larger-sized container, wherein the first pair of container support arms and the second pair of container support arms are held within a container support arm carrier, which container support arm carrier is pivotally mounted on the frame, a first end of the pneumatic cylinder is connected to the container support arm carrier, a mid-portion of the pneumatic cylinder is connected to the frame and the pneumatic cylinder is structured and arranged to rotate the first and second pairs of container support arms into and out of alignment with the corresponding product filling head.

Additionally, the container filling carousel can comprise a plurality of pairs of the side-by-side first and second container supports arranged around the carousel, and can operate when a product to be filled is either a liquid or a flowable solid.

In one form, a volume ratio of the small-sized container to the larger-sized container ranges from about 1:2 to 1:10, or from about 1:2 to 1:6, or from about 1:2 to 1:5, or even from about 1:2 to 1:4, and when a product to be filled is motor oil, the small-sized container has a first volume and the larger-sized container has a second volume four to five times that of the first volume, such as where the volume of the small-sized container is about one liter.

Additionally presented is a method of changing container sizes on a container filling carousel, comprising providing a container filling carousel with one or more pairs of side-by-side first and second container supports, each container support comprising a frame, a container support platform and at least one pair of container support arms above the container support platform, and wherein each of the container supports is structured and arranged to accept a first small-sized container, providing a product filling head above and corresponding to each of the first and second container supports, radially retracting the first container support from a side of the second container support and from beneath its corresponding product filling head, wherein the second container support is structured and arranged to accept a second larger-sized container, relative to the first small-sized container.

In this form, the frame of the first container support is pivotally connected to a lower mounting arm, a first end of a pneumatic cylinder is connected to the frame of the first container support and a second end of the pneumatic cylinder is connected to the lower mounting arm, the method further comprising actuating the pneumatic cylinder to pivotally retract the frame of the first container support radially inward of the carousel and remove the first container support from alignment with the corresponding product filling head.

Additionally, the second container support has two pair of container support arms, a first pair of container support arms being structured and arranged to accept the first small-sized container, and the second pair of container support arms being structured and arranged to accept the second larger-sized container, wherein the first pair of container support arms and the second pair of container support arms are held within a container support arm carrier, which container support arm carrier is pivotally mounted on the frame, a first end of a pneumatic cylinder is connected to the container support arm carrier, a mid-portion of the pneumatic cylinder is connected to the frame, the method further comprising actuating the pneumatic cylinder to rotate the first pair of container support arms out of alignment with the corresponding product filling head and to rotate the second pair of container support arms into alignment with the corresponding product filling head.

Also presented is a container support for supporting a container to be filled with a flowable material, comprising a frame, a container support platform connected to the frame, and at least one pair of foldable container support arms connected to the frame above the container support platform.

In one form the frame, the container support platform and the container support arms are pivotable about an axle in the frame.

In another form, the container support comprises two pair of container support arms, a first pair of container support arms being structured and arranged to accept a first small-sized container, and a second pair of container support arms being structured and arranged to accept a second larger-sized container.

Advantageously, the first pair of container support arms and the second pair of container support arms are held within a container support arm carrier, which container support arm carrier is pivotally mounted on an axle in the frame, and the first pair of container support arms is retractable by rotating on the axle in the frame to introduce the second pair of container support arms.

Conveniently, the container support platform is pivotable and structured and arranged to accommodate the second larger-sized container.

### BRIEF DESCRIPTION OF THE DRAWINGS

The present disclosure is susceptible to various modifications and alternative forms, specific exemplary implementations thereof have been shown in the drawings and are herein described in detail. It should be understood, however, that the description herein of specific exemplary implementations is not intended to limit the disclosure to the particular forms disclosed herein. Further, in the drawings, like reference numerals refer to similar elements.

FIGS. 1A and 1B show overhead schematics of the layout of the container filling carousel according to the present application.

FIG. 2 is a front view of the container filling carousel with a larger-sized container support in place and a small-sized container support retracted.

FIG. 3 is a front view of the small-sized container support and the larger-sized container support both configured for filling small-sized containers, in a side-by-side relationship as they would be installed in a container filling carousel of the present application.

FIG. 4 are side views of the small-sized container support (left) and the larger-sized container support (right).

FIG. 5 is a front view of the pair of container supports with the small-sized container support retracted and the larger-sized container support configured for holding and filling a larger-sized container.

FIG. 6 is a side view of the larger-sized container support when configured for holding and filling a larger-sized container.

FIG. 7 is a side view of the small-sized container support in a retracted position.

### DETAILED DESCRIPTION

The present disclosure is directed towards a container filling carousel which has simplified changeover capabilities for changing from one size container to another.

### Definitions

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

A/an: The articles “a” and “an” as used herein mean one or more when applied to any feature in embodiments and implementations of the present invention described in the specification and claims. The use of “a” and “an” does not limit the meaning to a single feature unless such a limit is specifically stated. The term “a” or “an” entity refers to one or more of that entity. As such, the terms “a” (or “an”), “one or more” and “at least one” can be used interchangeably herein.

About: As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

And/or: The term “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements). As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”.

Comprising: In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. Any device or method or system described herein can be comprised of, can consist of, or can consist essentially of any one or more of the described elements.

Ranges: Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and about 200, but also to include individual sizes such as 2, 3, 4, etc. and sub-ranges such as 10 to 50, 20 to 100, etc. Similarly, it should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds). In the figures, like numerals denote like, or similar, structures and/or features; and each of the illustrated structures and/or features may not be discussed in detail herein with reference to the figures. Similarly, each structure and/or feature may not be explicitly labeled in the figures; and any structure and/or feature that is discussed herein with reference to the figures may be utilized with any other structure and/or feature without departing from the scope of the present disclosure.

Carousel filling machines are characterized by their continuous motion, in which an array of filling nozzles or orifices rotate about a central spindle in a continuous circular manner. Empty containers to be filled with liquid are synchronously introduced into the machine and travel about the circumference of the structure. While each container is positioned under a circumferentially arranged filling head, it is completely filled with liquid. Each container is so positioned for most of one complete revolution of the machine before it is synchronously removed from the machine. However the ability to changeover from one size container to another size container is laborious and time consuming. The container supports which are accessible must be removed and replaced, then the machine rotated a partial rotation to be able to access additional container supports. This process might need to be repeated a number of times in order to remove and replace all of the container supports around the entire carousel.

Presented herein is a changeover method and apparatus for carousel filling machines having one or more pairs of side-by-side first and second container supports. The changeover can be conducted by human input, computer input or a combination of both. Each container support has a frame, a container support platform and at least one pair of foldable container support arms above the container support platform. Each of the container supports is structured and arranged to accept a first small-sized container and has a product filling head above it, corresponding to each of the first and second container supports. The first container support is radially retractable from a side of the second container support and from beneath its corresponding product filling head, and the second container support is structured and arranged to accept a second larger-sized container, relative to the first small-sized container, on demand. “On demand” means that the changeover from one configuration to the other configuration can be accomplished essentially immediately, since the small-sized container supports do not have to be removed from the carousel, but instead are retracted toward the center of the carousel. Due to the incorporation of pneumatic cylinders to effect necessary movements, the changeover process can be automated rather than manual, although manual (human initiated) changeover can be conducted if desired.

The second container support has two pair of container support arms, a first pair of container support arms structured to accept the first small-sized container, and a second pair of container support arms structured to accept the second larger-sized container. The first pair of container support arms of the second container support is foldable and retractable by pivoting on an axle in the frame of the second container support to introduce the second pair of container support arms. The second pair of container support arms is foldable and is stored below and behind the second container support by rotating them on a container support arm carrier, to which is attached both the container support arms for the small-sized containers and the container support arms for the larger-sized containers. The container support arm carrier is attached to a pneumatic cylinder which can be activated to rotate either set of container support arms into or out of alignment with the corresponding product filling head. A plunger end of the pneumatic cylinder is pivotally connected to the container support arm carrier and a mid-portion of the pneumatic cylinder is pivotally connected to the frame.

When it is desired to fill larger-sized containers, the first container support is retracted radially inward, relative to the carousel, from the side of the second container support by actuating a pneumatic cylinder to cause the first container support to pivot on an axle positioned through its frame and lower mounting arm and remove it from alignment with its corresponding product filling head. The pneumatic cylinder is pivotally attached on one of its ends to the frame of the container support and on the other end to the lower mounting arm, which is affixed to the carousel at its lower portion and supports the first container support frame at the axle on its upper portion.

The container filling carousel has a plurality of pairs of the side-by-side first and second container supports arranged around the carousel, and can operate when a product to be filled is either a liquid or a flowable solid. The number of container supports around the carousel is halved when filling the larger-sized containers. For example, when configured for the small-sized containers, such as quart or liter containers, the carousel can have twenty, fourty or even sixty filling positions. But when it is changed-over to fill the larger-sized containers, e.g. four to five quart or liter containers, which are about double the width of the small-sized containers, all of the small-sized container supports are retracted inward towards the center of the carousel, resulting in only one half the number of container supports, i.e. the larger ones, being in the filling position. Each of the container supports is provided with an electronic weighing apparatus below the support platforms thereof, to allow the system to accurately and consistently fill each container with the appropriate amount of product.

The volume ratio of the small-sized containers to the larger-sized containers ranges from about 1:2 to 1:10, or from about 1:2 to 1:6, or from about 1:2 to 1:5, or even from about 1:2 to 1:4, and when a product to be filled is motor oil, the small-sized containers have a first volume and the larger-sized containers have a second volume four to five times that of the first volume, such as where the volume of the small-sized containers is about one liter and the volume of the larger sized containers is about four to five liters.

Additionally presented is a method of changing container sizes on a container filling carousel, comprising providing a container filling carousel with one or more pairs of side-by-side first and second container supports, each container support comprising a frame, a container support platform and at least one pair of container support arms above the container support platform, and wherein each of the container supports is structured and arranged to accept a first small-sized container, providing a product filling head above and corresponding to each of the first and second container supports, radially retracting the first container support from a side of the second container support and from beneath its corresponding product filling head, wherein the second container support is structured and arranged to accept a second larger-sized container, relative to the first small-sized container.

The frame of the first container support is pivotally connected to a lower mounting arm, a first end of a pneumatic cylinder is connected to the frame of the first container support and a second end of the pneumatic cylinder is connected to the lower mounting arm, the method further comprising actuating the pneumatic cylinder to pivotally retract the frame of the first container support radially inward of the carousel and remove the first container support from alignment with the corresponding product filling head.

Additionally, the second container support has two pair of container support arms, a first pair of container support arms being structured and arranged to accept the first smaller-sized container, and the second pair of container support arms being structured and arranged to accept the second larger-sized container, wherein the first pair of container support arms and the second pair of container support arms are connected to a container support arm carrier, which container support arm carrier is pivotally mounted on the frame, a first end of a pneumatic cylinder is connected to the container support arm carrier, a mid-portion of the pneumatic cylinder is connected to the frame, the method further comprising actuating the pneumatic cylinder to rotate the first pair of container support arms out of alignment with the corresponding product filling head and to rotate the second pair of container support arms into alignment with its corresponding product filling head.

Also presented is a container support for supporting a container to be filled with a flowable material, comprising a frame, a container support platform connected to the frame, and at least one pair of foldable container support arms connected to the frame above the container support platform.

In one form for the small-container support, the frame, the platform and the container support arms are pivotable about an axle in the frame.

In another form, the larger-container support comprises two pair of container support arms, a first pair of container support arms being structured and arranged to accept a first small-sized container, and a second pair of container support arms being structured and arranged to accept a second larger-sized container. The first pair of container support arms and the second pair of container support arms are held within a container support arm carrier, which container support arm carrier is pivotally mounted on an axle in the frame, and the first pair of container support arms is retractable by rotating on the axle in the frame to introduce the second pair of container support arms. The container support platform of the second, larger-sized container support is pivotable and structured and arranged to accommodate the second larger-sized container.

The apparatus and method will become clearer upon consideration of the figures, which are described in detail below.

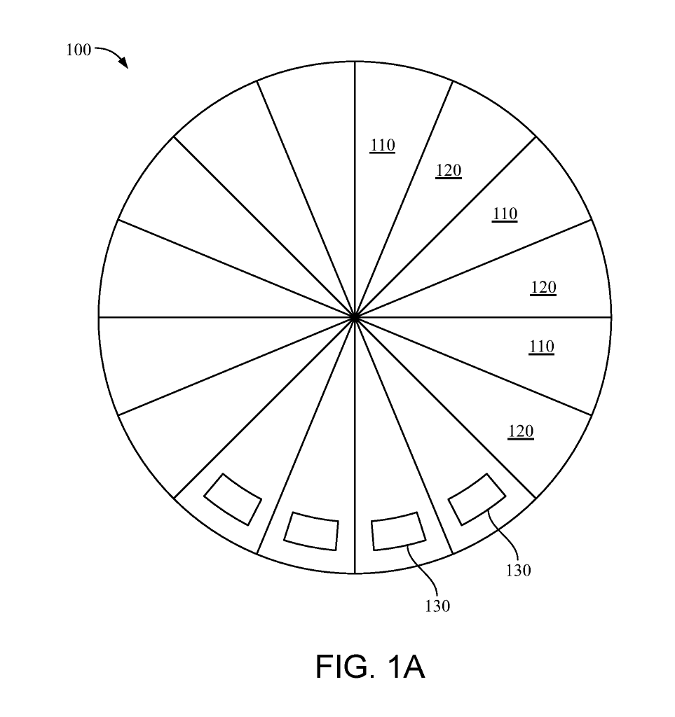

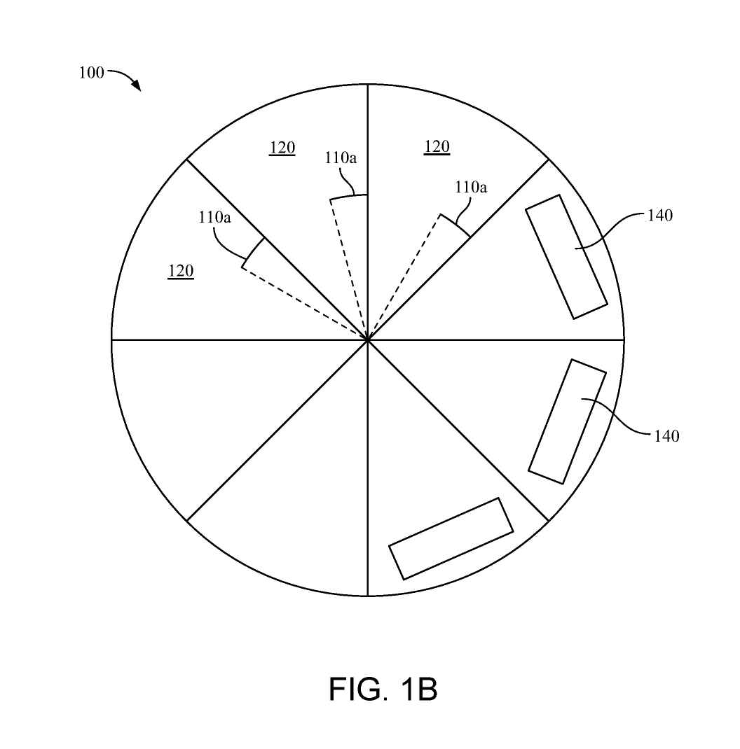

FIGS. 1A and 1B show overhead schematics of the layout of the container filling carousel according to the present application. FIG. 1A illustrates the carousel filling machine 100 which is radially separated into a number of side-by-side sections having first, small-sized container supports 110 deployed, and second, larger-sized container supports 120. In this configuration the carousel filling machine accepts a small-sized container 130 on each of the first and second container supports 110, 120. FIG. 1B illustrates the carousel filling machine after changeover to accommodate a larger-sized container 140, in which the first container supports 110a are in radially retracted positions, and only the second container supports 120 are in a position for filling. Of course, filling heads above the first container supports 110a are closed in this configuration.

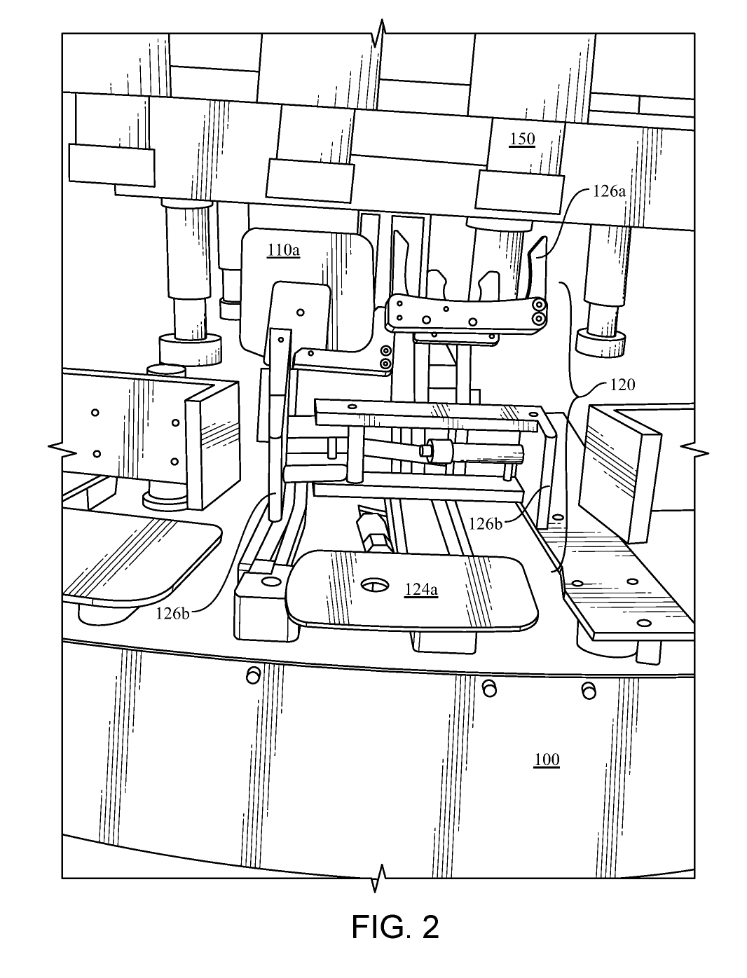

FIG. 2 is a front view of the container filling carousel 100 with a larger-sized container support 120 in place. The retracted small-sized container support 110a is seen to the left of and behind the larger-sized support. Larger-sized container support 120 includes a container support platform 124a, pivoted in this view to accommodate a larger-sized container, container support arms 126b, again configured for a larger-sized container, and container support arms 126a, rotated above and behind the larger-sized container support arms 126b. A liquid filler head 150 is positioned over the location of a fill neck on a larger-sized container sitting in the container support.

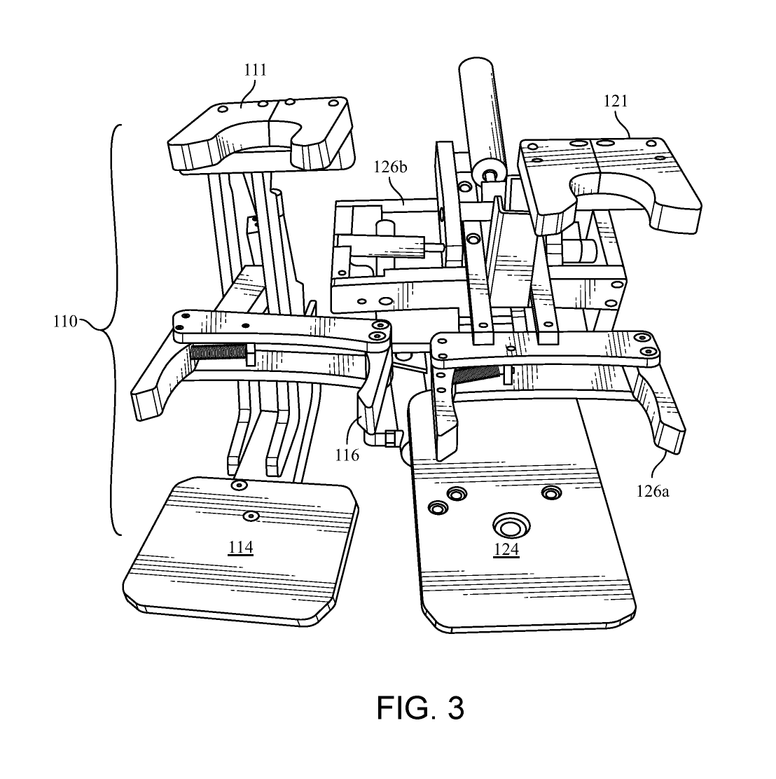

FIG. 3 is a front view of the small-sized container support 110 and larger-sized container support 120 configured for a small-sized container, in a side-by-side relationship as they would be installed in a container filling carousel 100 of the present application. Small-sized container support 110 has a container support platform 114, container support arms 116 and a container neck support 111. On the right, the larger-sized container support 120 is configured to accept the small-sized containers, having the small-sized container support arms 126a deployed to the filling position, while container support arms 126b for the larger-sized containers are folded and rotated behind the filling position, and the container support platform 124 is rotated with its long dimension radial with respect to the carousel, to better accommodate the small-sized container. The larger-sized support also has a container neck support 121 when it is configured for the small-sized container, such as a quart or liter sized container for motor oil.

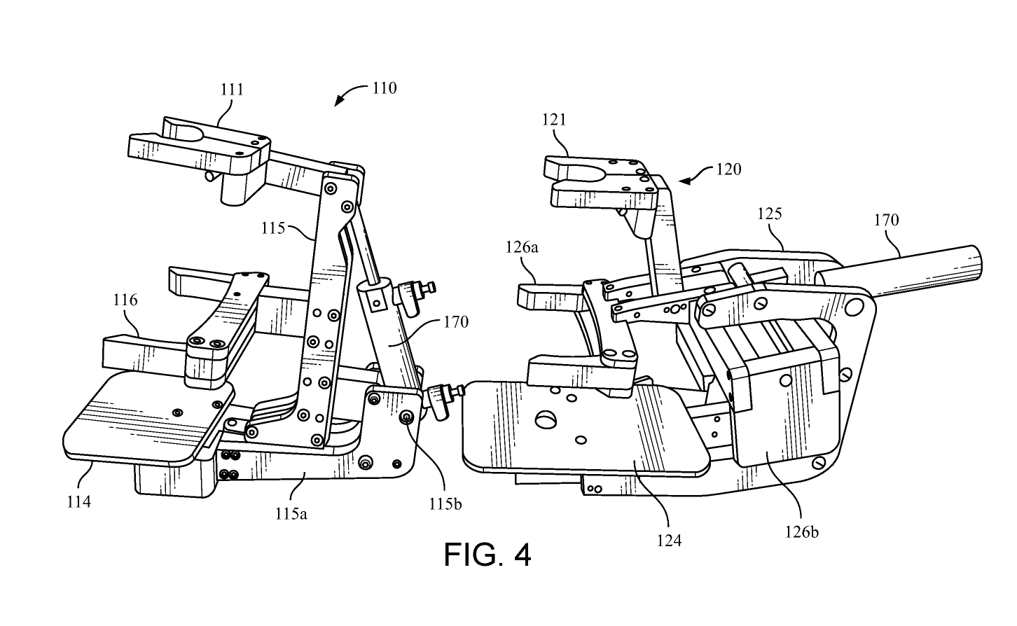

FIG. 4 are side views of the small-sized container support 110 and the larger-sized container support 120. In this figure, both supports are configured for the small-sized containers. Both container supports incorporate frames 115, 125, which hold the various elements in their proper places. The small-sized container support 110 has frame 115 and a lower mounting arm 115a, which are connected through axle 115b with a pneumatic cylinder 170, one end of which is pivotally connected to the top of frame 115 and the other end of which is pivotally supported on axle 115b located on the upper, rear portion of lower mounting arm 115a. The relationship between the small-sized container arms 126a and the larger-sized container arms 126b, when container support 120 is configured for the small-sized containers is evident. The two sets of container support arms are substantially perpendicular, one to the other. Larger-container support arms 126b, one of which is folded, are pivoted behind the filling location and behind container support platform 124, which is configured to support the small-sized containers, having its longer dimension pivoted radially in line with the carousel. Container support 120 is also provided with a pneumatic cylinder 170, which acts to rotate the container support arms 126a and 126b from one position to the other.

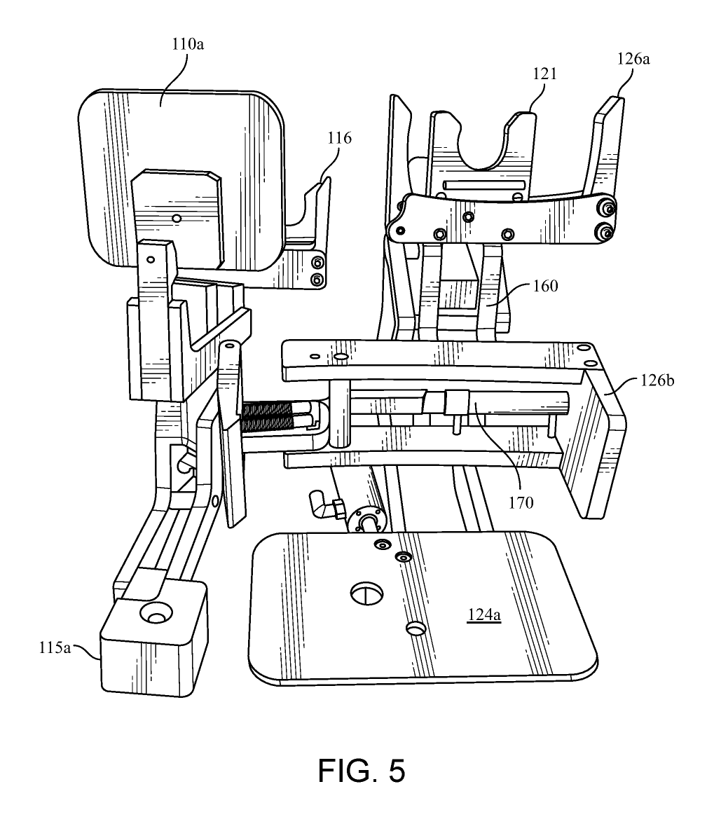

FIG. 5 is a front view of the pair of container supports 110, 120, with the small-sized support 110a retracted and the larger-sized support 120 configured for a larger-sized container, similar to FIG. 2. The position of the front portion of small-sized container lower mounting arm 115a is evident in this view. In this configuration the container support platform 124a is pivoted circumferentially relative to the carousel, such that its longer dimension is in position to support a larger-sized container, such as a four to five quart or liter motor oil container. Since the larger containers are wider than the smaller containers, neck fill support 121 is not necessary to maintain the containers upright during the filling process. Container support arms 126b, attached to a container support arm carrier 160, are rotated to the front, unfolded and extended to fit the larger-sized containers. Unfolding and extension of the container support arms is accomplished by actuation of pneumatic cylinder 170. Container support arms 116 and 126a for the small-sized containers are radially retracted into the carousel.

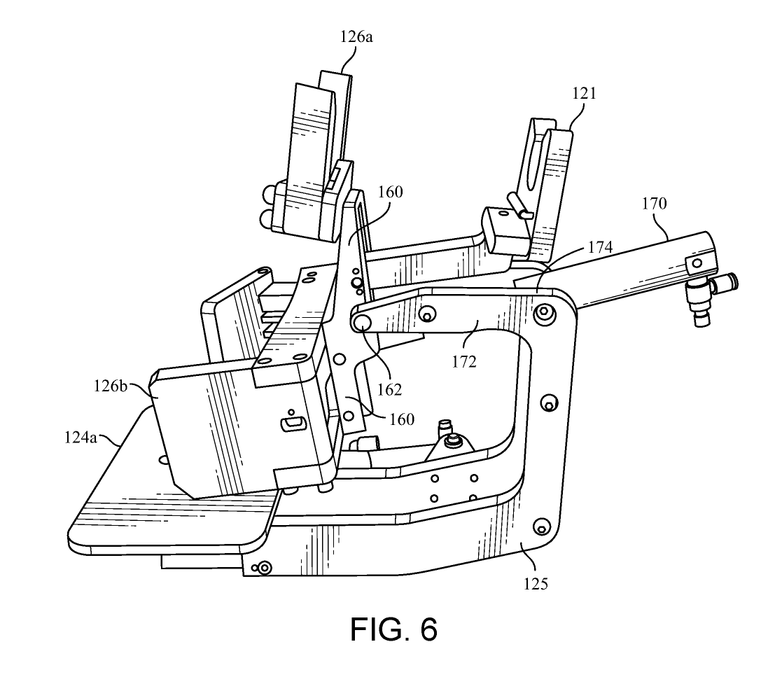

FIG. 6 is a side view of the larger-sized container support when configured for a larger-sized container. The relationship of the two container support arms 126a, 126b and their attachment to container support arm carrier 160 are clarified in this side view, as well as the configuration of the elements of the container support as they are supported in the frame 125. The container support arm carrier 160 is pivoted around axle 162 by actuation of pneumatic cylinder 170, a first end 172 of which is attached to the support arm carrier 160, and a mid-portion 174 of which is pivotally attached to frame 125.

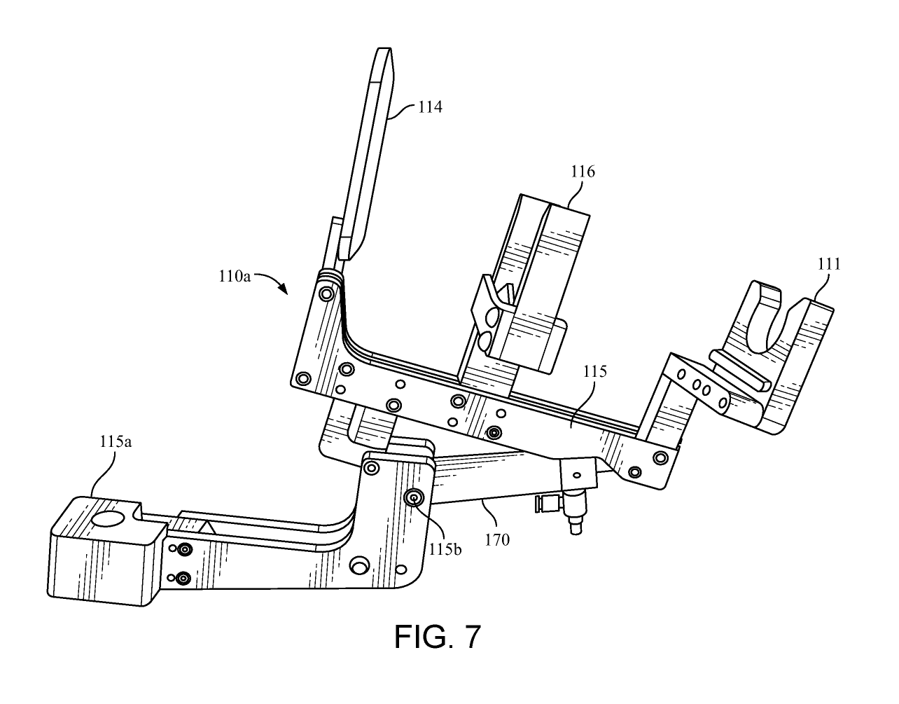

FIG. 7 is a side view of the small-sized container support 110a in a retracted position, which clarifies the locations of the elements thereof when retracted. Pneumatic cylinder 170 is actuated and pulls frame 115 so as to pivot it around axle 115b in the lower mounting arm 115a. Since all of the container support platform 114, the container support arms 116 and the container neck support 111 are connected to frame 115, all are retracted radially into the carousel.

Further illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action. The present invention has been described above with reference to numerous embodiments and specific examples. Many variations will suggest themselves to those skilled in this art in light of the above detailed description. All such obvious variations are within the full intended scope of the appended claims.

### ILLUSTRATIVE EMBODIMENTS OF THE INVENTION

1. A container filling carousel, comprising one or more pairs of side-by-side first and second container supports, each container support comprising a frame, a container support platform and at least one pair of container support arms above the container support platform, and wherein each of said container supports is structured and arranged to accept a first small-sized container; a product filling head above and corresponding to each of said first and second container supports; wherein the first container support is radially retractable from a side of the second container support and from beneath its corresponding product filling head; and wherein the second container support is structured and arranged to accept a second larger-sized container, relative to said first small-sized container, on demand.

2. The container filling carousel of clause 1, wherein the second container support has two pair of container support arms, a first pair of container support arms being structured and arranged to accept the first small-sized container, and a second pair of container support arms being structured and arranged to accept the second larger-sized container.

3. The container filling carousel of clause 1 or 2, wherein the first container support is retractable from the side of the second container support by pivoting on an axle in said frame of said first container support.

4. The container filling carousel of clause 2 or 3, wherein said first pair of container support arms of said second container support is retractable by rotating on an axle in said frame of said second container support to introduce said second pair of container support arms.

5. The container filling carousel of any of preceding clauses 1 to 4, wherein the frames for both the first and second container supports are connected to at least one pneumatic cylinder structured and arranged to cause movement of one or more elements of said first and second container supports.

6. The container filling carousel of clause 5, wherein the frame of the first container support is pivotally connected to a lower mounting arm, a first end of the pneumatic cylinder is connected to said frame of said first container support and a second end of said pneumatic cylinder is connected to said lower mounting arm, and said pneumatic cylinder is structured and arranged to retract said frame of the first container support radially inward of said carousel and remove said first container support from alignment with the corresponding product filling head.

7. The container filling carousel of clause 5, wherein the second container support has two pair of container support arms, a first pair of container support arms being structured and arranged to accept the first small-sized container, and the second pair of container support arms being structured and arranged to accept the second larger-sized container, wherein said first pair of container support arms and said second pair of container support arms are held within a container support arm carrier, which container support arm carrier is pivotally mounted on said frame, a first end of the pneumatic cylinder is connected to said container support arm carrier, a mid-portion of the pneumatic cylinder is connected to said frame and the pneumatic cylinder is structured and arranged to rotate said first and second pairs of container support arms into and out of alignment with the corresponding product filling head.

8. The container filling carousel of any of preceding clauses 1 to 7, comprising a plurality of pairs of said side-by-side first and second container supports arranged around said carousel.

9. The container filling carousel of any of preceding clauses 1 to 8, wherein a product to be filled is either a liquid or a flowable solid.

10. The container filling carousel of any of preceding clauses 1 to 9, wherein a volume ratio of said small-sized container to said larger-sized container ranges from about 1:2 to 1:10, or from about 1:2 to 1:6, or from about 1:2 to 1:5, or even from about 1:2 to 1:4.

11. The container filling carousel of any of preceding clauses 1 to 10, wherein a product to be filled is motor oil, the small-sized container has a first volume and the larger-sized container has a second volume four to five times that of the first volume.

12. The container filling carousel of any of preceding clauses 1 to 11, wherein a volume of the small-sized container is about one liter.

13. A method of changing container sizes on a container filling carousel, comprising providing a container filling carousel with one or more pairs of side-by-side first and second container supports, each container support comprising a frame, a container support platform and at least one pair of container support arms above the container support platform, and wherein each of said container supports is structured and arranged to accept a first small-sized container; providing a product filling head above and corresponding to each of said first and second container supports; radially retracting the first container support from a side of the second container support and from beneath its corresponding product filling head, wherein the second container support is structured and arranged to accept a second larger-sized container, relative to said first small-sized container.

14. The method of clause 13, wherein the frame of the first container support is pivotally connected to a lower mounting arm, a first end of a pneumatic cylinder is connected to said frame of said first container support and a second end of the pneumatic cylinder is connected to said lower mounting arm, said method further comprising actuating said pneumatic cylinder to pivotally retract said frame of the first container support radially inward of said carousel and remove said first container support from alignment with the corresponding product filling head.

15. The method of clause 13, wherein the second container support has two pair of container support arms, a first pair of container support arms being structured and arranged to accept the first small-sized container, and the second pair of container support arms being structured and arranged to accept the second larger-sized container, wherein said first pair of container support arms and said second pair of container support arms are held within a container support arm carrier, which container support arm carrier is pivotally mounted on said frame, a first end of a pneumatic cylinder is connected to said container support arm carrier, a mid-portion of the pneumatic cylinder is connected to said frame, the method further comprising actuating said pneumatic cylinder to rotate the first pair of container support arms out of alignment with the corresponding product filling head and to rotate said second pair of container support arms into alignment with the corresponding product filling head.

16. A container support for supporting a container to be filled with a flowable material, comprising a frame, a container support platform connected to the frame, and at least one pair of foldable container support arms connected to the frame above the container support platform.

17. The container support of clause 16, wherein the frame, the container support platform and the container support arms are pivotable about an axle in the frame.

18. The container support of clause 16, comprising two pair of container support arms, a first pair of container support arms being structured and arranged to accept a first small-sized container, and a second pair of container support arms being structured and arranged to accept a second larger-sized container.

19. The container support of clause 18, wherein said first pair of container support arms and said second pair of container support arms are held within a container support arm carrier, which container support arm carrier is pivotally mounted on an axle in said frame, and the first pair of container support arms is retractable by rotating on the axle in the frame to introduce said second pair of container support arms.

20. The container support of any of clauses 16, 18 or 19, wherein the container support platform is pivotable and structured and arranged to accommodate the second larger-sized container.

### INDUSTRIAL APPLICABILITY

The systems and methods disclosed herein are applicable to the petroleum industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A container filling carousel, comprising:
one or more pairs of side-by-side first and second container supports, each container support comprising a frame, a container support platform and at least one pair of container support arms above the container support platform, and wherein each of said container supports is structured and arranged to accept a first small-sized container;
a product filling head above and corresponding to each of said first and second container supports;
wherein the first container support is radially retractable from a side of the second container support and from beneath its corresponding product filling head; and
wherein the second container support is structured and arranged to accept a second larger-sized container, relative to said first small-sized container, on demand.

2. The container filling carousel of claim 1, wherein the second container support has two pair of container support arms, a first pair of container support arms being structured and arranged to accept the first small-sized container, and a second pair of container support arms being structured and arranged to accept the second larger-sized container.

3. The container filling carousel of claim 2, wherein said first pair of container support arms of said second container support is retractable by rotating on an axle in said frame of said second container support to introduce said second pair of container support arms.

4. The container filling carousel of claim 1, wherein the first container support is retractable from the side of the second container support by pivoting on an axle in said frame of said first container support.

5. The container filling carousel of claim 1, wherein the frames for both the first and second container supports are connected to at least one pneumatic cylinder structured and arranged to cause movement of one or more elements of said first and second container supports.

6. The container filling carousel of claim 5, wherein the frame of the first container support is pivotally connected to a lower mounting arm, a first end of the pneumatic cylinder is connected to said frame of said first container support and a second end of said pneumatic cylinder is connected to said lower mounting arm, and said pneumatic cylinder is structured and arranged to retract said frame of the first container support radially inward of said carousel and remove said first container support from alignment with the corresponding product filling head.

7. The container filling carousel of claim 5, wherein the second container support has two pair of container support arms, a first pair of container support arms being structured and arranged to accept the first small-sized container, and the second pair of container support arms being structured and arranged to accept the second larger-sized container, wherein said first pair of container support arms and said second pair of container support arms are held within a container support arm carrier, which container support arm carrier is pivotally mounted on said frame, a first end of the pneumatic cylinder is connected to said container support arm carrier, a mid-portion of the pneumatic cylinder is connected to said frame and the pneumatic cylinder is structured and arranged to rotate said first and second pairs of container support arms into and out of alignment with the corresponding product filling head.

8. The container filling carousel of claim 1, comprising a plurality of pairs of said side-by-side first and second container supports arranged around said carousel.

9. The container filling carousel of claim 1, wherein a product to be filled is either a liquid or a flowable solid.

10. The container filling carousel of claim 1, wherein a volume ratio of said small-sized container to said larger-sized container ranges from about 1:2 to 1:10, or from about 1:2 to 1:6, or from about 1:2 to 1:5, or even from about 1:2 to 1:4.

11. The container filling carousel of claim 1, wherein a product to be filled is motor oil, the small-sized container has a first volume and the larger-sized container has a second volume four or five times that of the first volume.

12. The container filling carousel of claim 1, wherein a volume of the small-sized container is about one liter.

13. A method of changing container sizes on a container filling carousel, comprising:
providing a container filling carousel with one or more pairs of side-by-side first and second container supports, each container support comprising a frame, a container support platform and at least one pair of container support arms above the container support platform, and wherein each of said container supports is structured and arranged to accept a first small-sized container;
providing a product filling head above and corresponding to each of said first and second container supports;
radially retracting the first container support from a side of the second container support and from beneath its corresponding product filling head,
wherein the second container support is structured and arranged to accept a second larger-sized container, relative to said first small-sized container.

14. The method of claim 13, wherein the frame of the first container support is pivotally connected to a lower mounting arm, a first end of a pneumatic cylinder is connected to said frame of said first container support and a second end of the pneumatic cylinder is connected to said lower mounting arm, said method further comprising actuating said pneumatic cylinder to pivotally retract said frame of the first container support radially inward of said carousel and remove said first container support from alignment with the corresponding product filling head.

15. The method of claim 13, wherein the second container support has two pair of container support arms, a first pair of container support arms being structured and arranged to accept the first small-sized container, and the second pair of container support arms being structured and arranged to accept the second larger-sized container, wherein said first pair of container support arms and said second pair of container support arms are held within to a container support arm carrier, which container support arm carrier is pivotally mounted on said frame, a first end of a pneumatic cylinder is connected to said container support arm carrier, a mid-portion of the pneumatic cylinder is connected to said frame, the method further comprising actuating said pneumatic cylinder to rotate the first pair of container support arms out of alignment with the corresponding product filling head and to rotate said second pair of container support arms into alignment with the corresponding product filling head.

16. A container support for supporting a container to be filled with a flowable material, comprising:
a frame;
a container support platform connected to said frame; and
at least one pair of foldable container support arms connected to the frame above the container support platform.

17. The container support of claim 16, wherein the frame, the container support platform and the container support arms are pivotable about an axle in the frame.

18. The container support of claim 16, comprising two pair of container support arms, a first pair of container support arms being structured and arranged to accept a first small-sized container, and a second pair of container support arms being structured and arranged to accept a second larger-sized container.

19. The container support of claim 18, wherein said first pair of container support arms and said second pair of container support arms are held within a container support arm carrier, which container support arm carrier is pivotally mounted on an axle in said frame, and the first pair of container support arms is retractable by rotating on the axle in the frame to introduce said second pair of container support arms.

20. The container support of claim 18, wherein the container support platform is pivotable and structured and arranged to accommodate the second larger-sized container.
